(19) United States
(12) Patent Application Publication
(10) Pub. No.: US 2020/0334588 A1
(43) Pub. Date: Oct. 22, 2020

(54) METHOD FOR UPDATING AN AVAILABILITY INDICATOR OF A VEHICLE FOR RESERVING SAME

(71) Applicant: VULOG, Nice (FR)

(72) Inventor: François COLON, Marseille (FR)

(73) Assignee: VULOG, Nice (FR)

(21) Appl. No.: 16/959,216

(22) PCT Filed: Jan. 7, 2019
(86) PCT No.: PCT/FR2019/050028

§ 371 Date: Jun. 30, 2020

(30) Foreign Application Priority Data
Jan. 9, 2018 (FR) 1850152

(51) Int. Cl. G06Q 10/02; G07C 5/00; G07C 9/00; G08G 1/00; H04W 4/40; H04W 4/80; H04W 28/04; H04W 40/22; H04W 4/02; B60R 25/24

(52) U.S. Cl. CPC G06Q 10/02; G07C 5/008; G07C 9/00309; G08G 1/205; B60R 25/241; H04W 4/80; H04W 28/04; H04W 40/22; H04W 4/023; H04W 4/40

(57) ABSTRACT

A method for updating a database for returning a vehicle which includes generating an availability indicator; transmitting the availability indicator to at least one user device belonging to a first user via a short-range wireless link; saving all the information in a memory of the device until subsequently detecting access to a data network; automatically transmitting all the information including said availability indicator to a remote server; and updating a database modifying a vehicle availability status within a fleet of vehicles by a computer of the remote server.

### FIELD

The invention relates to a method for updating a vehicle availability indicator for reservation thereof. The field of the invention relates in particular to methods for reserving and making available a vehicle in order to retrieve it in a fleet of vehicles available for reservation. The field of the invention relates more particularly to the methods implemented from a smartphone or portable electronic equipment used for releasing or accessing a vehicle not covered by a data network.

### PRIOR ART

There exist methods for reserving and making available a vehicle, in particular a motor car. In these methods, generally a private vehicle or one from a trade fleet is made available in a stock of vehicles. The document CN 105957262 describes a solution for reserving a vehicle.

Solutions for reserving and activating the opening of the vehicle by means of a mobile terminal are known.

The document US 2015/0137943 describes such a solution. The mobile terminal is in this case used for interrogating a remote server in order to check the availability of the vehicles, to select one of them and to request authorisations for access to the vehicle. In this solution, the vehicle itself has means of access to a network and can transfer information to a remote server in particular on its availability. The server can then transmit information directly to the vehicle.

There exist solutions in which the vehicle and the terminal exchange information, for example a status of the vehicle or even advertising information.

The document US 2011/0034128 describes such a solution. The vehicle and the terminal of a user of a service exchange information, in particular on a purpose of use of the vehicle. In this case, the terminal is capable, for example, of switching off a vehicle. The data may, furthermore, be transferred to a remote server in order to be recorded.

However, there exists a problem when the vehicle is parked, for example, in a place not covered by a data network. This may occur in underground car parks or in closed garages.

In the latter case, after use of a vehicle, the latter cannot communicate its state to a remote server, for example a state of availability.

The document WO 2013/045838 relates to a method for managing a parking location on one or more rental sites. This method does not apply the transmission of information between a remote server and a vehicle parked in a place not covered by a data network.

The document FR 2980949 relates to a system for communication between unconnected equipment a data network and a remote management server. This system is however not suited to the management of a vehicle availability indicator for reservation thereof, when this vehicle is parked in a place not covered by a data network.

### SUMMARY OF THE INVENTION

The invention aims to overcome the aforementioned drawbacks.

The solution proposed by the invention is a method for updating a database for retrieving a vehicle, comprising the following steps:
Generation of a vehicle availability indicator from a computer in the vehicle;
Automatic transmission of a set of information comprising said availability indicator to at least one item of user equipment of a first user via a short-range wireless connection;
Recording of the set of information in a memory of the equipment until subsequent detection of an access to a data network;
Automatic transmission of the set of information comprising said availability indicator to a remote server from the user equipment via a wireless connection affording access to a data network;
Updating of a database modifying a vehicle availability status in a vehicle fleet by a computer of the remote server.

The user equipment is here used as a data processing gateway. This equipment is a transport carrier, in particular of the availability indicator, which is naturally quicker to find a data network for communicating with the remote server since it is carried by a user. The data can thus be transferred to the remote server in order to be recorded, even when the vehicle is parked in a place not covered by a data network.

Other advantageous features of the invention are listed below. Each of these features can be considered alone or in combination with the remarkable features defined above, and being the subject, where applicable, of one or more divisional patent applications:
The generation of the availability indicator is advantageously generated following: a digital command generated following the stoppage of the vehicle or of its electrical management system; and/or a digital command generated following the closure of a door; and/or a digital command generated following the reception of a message from a wireless communication interface coming from a user terminal comprising end-of-use data.
Advantageously, the automatic transmission of the set of information is performed after a first failed attempt at transmission of said set of information from equipment on board the vehicle, to the remote server, through the data network, and a first recording of said information in a memory of the first item of equipment.
The short-range connection is preferentially a Bluetooth connection.
The set of information advantageously comprises: an identifier of the vehicle; an IP address or a URL; a secret shared with a remote server; a token comprising a timestamp.
The method may further comprise the following steps: comparison of the tokens and identifiers received from a plurality of received messages coming from a plurality of items of equipment; deletion of any availability indicators in a doublet coming from the same vehicle.
Updating of the database of the remote server may further comprise the following steps: recording of a new parking location of the vehicle; recording of use data comprising at least one of the following data:
   Use time;
   Kilometres travelled;
   Triggering of events (airbag, review of alert, etc.).
The method may comprise a step of modifying the availability status of the vehicle for reservation thereof by a second user comprising: identification of the second user recorded in a database of a service of access to a fleet of vehicles; generation of a free-access indicator for a vehicle; first transmission, by a server, intended for at least a second user, of a set of information comprising the free-access indicator; automatic second transmission of the set of information comprising said free-access indicator to at least one vehicle via a short-range wireless connection; recording of the set of information received by a vehicle in a memory of said vehicle; activation of an unlocking of the access to the vehicle.
The free-access indicator is advantageously associated with the identifier of a second user, the second set of information transmitted to the vehicle further comprising a user identifier.
The method may further comprise the following step: reception by the server of a request for access to a vehicle by the second user prior to the generation of a free-access indicator.
Advantageously, the method comprises, following the identification of the second user, a comparison between at least one position of the vehicle and a position of said second user in order to activate the generation of a free-access indicator for this second user to be transmitted to the vehicle.
Advantageously, the method comprises, following the request for access, a selection of a vehicle from the second item of equipment among a list of vehicles generated by said server.
Advantageously, the method comprises the following steps:
Detection, by an item of equipment in the vehicle, of an access to a data network via a long-range wireless connection;
Automatic transmission, to the remote server, by the equipment of the vehicle, of vehicle data and data of association with the new user;
Updating of a database modifying a vehicle availability status in a fleet of vehicles by a computer of the remote server.

Another aspect of the invention relates to a system comprising at least one mobile terminal and a server for performing any one of the steps of the method defined above.

### BRIEF DESCRIPTION OF THE FIGURES

Other features and advantages of the invention will emerge from a reading of the following detailed description, with reference to the accompanying drawings, which illustrate:

FIG. 1: a representation of a case of use of the invention when a vehicle in a fleet able to be reserved on line is not covered by a data network;

FIG. 2: an example embodiment of implementation of the steps of the invention in order to modify a vehicle availability status.

### DESCRIPTION

### Access to the Service

In the remainder of the description, “a service” will mean: all the functionalities proposed and provided by the server SERV and by at least one item of equipment EQi connected to the server SERV by means of a data network. The service may comprise for example the following functionalities:
reservation of a vehicle from a list of available vehicles;
location of a vehicle for example on a digital map displayed on the user equipment EQi;
the making available of a reserved vehicle after a period of use;
remote release of a vehicle after a validated reservation;
remote locking of a vehicle after an end of use of a vehicle in the fleet;
Etc.

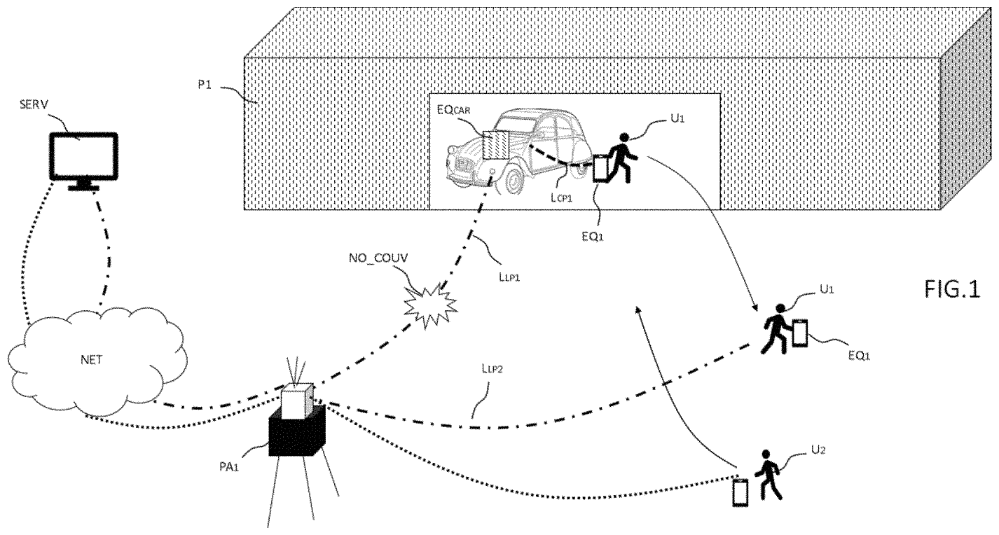

FIG. 1 depicts four entities including a first item of equipment EQ₁ of a user U₁, a second item of equipment EQ₂ of a second user U₂, a remote server, denoted SERV, and an item of equipment EQ_{CAR} disposed in a vehicle CAR.

The vehicle CAR is a vehicle in a fleet of vehicles dedicated to hire by users subscribing to a service.

### Authentication to the Service, Registration

According to one embodiment, each user Ui is registered with a rights management server, which may or may not be the remote server SERV. The users Ui access a service corresponding to access to a set of vehicles in a fleet.

According to one embodiment, a user is registered with a web service of a remote server associated with the service.

The registration comprises the registration of a user identifier Ui and a network address @EQi of the user equipment EQi, it may be a port, an IP address, an MAC address or any other address or combinations of elements constituting addresses for identifying user equipment EQi.

According one embodiment, the users Ui are pre-entered from software and are known because an identifier is registered in a remote database. According to one embodiment, a database associates a vehicle CAR with a user Ui when the latter uses a vehicle CAR. According to one embodiment, the server SERV has a function for performing the associations.

In the context of the invention, an item of user equipment is used by the vehicle as a relay for transmitting data to a remote server SERV. The exchanges between the equipment of the vehicle EQ_{CAR} and user equipment EQ₁, may therefore comprise authentication data.

At the launch of the program, the equipment EQ₁ and the equipment EQ_{CAR} attempt to establish a short-range connection L_{CP1} in order to exchange a message M₁ so that it is transmitted via a data network NET to a remote server SERV. The message M₁ may then, for example, comprise data enabling certain temporary rights to be delivered to a user U₁ so that he can exchange data with the remote server SERV, in particular to activate an update of the database that is managed by the server SERV.

The server SERV may then be coupled or not to another authentication server, for example to make it possible to recognise the user Ui and to associate predefined rights with him For example, an authentication server may, for example, manage user rights relating to a set of users of a service for hire of a fleet of vehicles and associated services making it possible to activate the making available of a vehicle in the fleet in place of the vehicle.

### Equipment, Server

According to a first embodiment, the equipment EQ₁, EQ₂ is mobile electronic equipment comprising a communication interface, for example GSM, GPRS 3G, UMTS, 4G, LTE or Wi-Fi, for establishing a wireless communication connection with communication equipment of a data network, such as the internet. The communication equipment may for example be a switch, a router, a server of a network, a base station of a network of mobile terminals such as an enodeB or a nodeB for the LTE or UMTS networks.

The equipment EQ₁, EQ₂ is preferentially smartphones or digital tablets. According to one embodiment, the equipment comprises, for example, an executable code of a downloadable application making it possible to perform the functions of the methods of the invention.

The server SERV performs certain steps of the method of the invention that may also correspond to functions of software. It may be a single item of equipment such as a computer comprising resources for performing the functions of a server. According to an alternative of the invention, the functions of the server SERV may be provided by a plurality of servers, that is to say computers. By way of example, an authentication server, making it possible in particular to manage the user rights and a server storing the information of the fleet of vehicles, may be configured to implement the method of the invention.

According to another example, the data of the users and the data of the vehicles are stored in a cloud, comprising a plurality of memory resources synchronised with each other and accessible from the data network NET.

### Context of the Invention

The vehicle CAR is in the context of the invention a vehicle in a fleet of vehicles available for reservation via a service to which users are subscribing. A reservation system makes it possible, from equipment EQi, to reserve an available vehicle by generating a request with a server SERV.

The request is then transmitted via a data network NET, depicted in FIG. 1, for example the internet. One advantage of such a network is to enable users easily to reserve their vehicle from almost anywhere. The server SERV can then manage vehicle availability information in order to inform the subscribers to this service of the location of the vehicles and the availability thereof. After a use of a vehicle, the availability information is then updated by sending messages from the vehicle CAR to the server SERV. The server SERV is, in this example, accessible from the network NET.

The invention is placed in a context wherein a vehicle CAR in the fleet is parked in an area P₁ not covered by a data network NET, such as a closed car park, a basement or any other place not having sufficient exposure to allow passage of wireless communications with a point PA₁ of access to the data network.

The network NET relies on an infrastructure for routing wireless communications coming from mobile terminals to network equipment and vice versa. The point P_{A1} of access to the network NET may for example be a relay terminal, a base station, a Wi-Fi domestic access point or any other network equipment able to provide a communication interface with a data network, such as for example the internet.

FIG. 1 depicts a case wherein the vehicle CAR has been used by a first user U₁. The latter for example parks the vehicle CAR in a closed car park P1 after having used it. The vehicle CAR then once again becomes available for other users. However, in this case, the car park P1 does not enable the vehicle CAR, and more particularly its equipment EQ_{CAR}, to receive or send data within the data network NET via the access point PA₁. The isolation of the vehicle CAR vis-à-vis the network is represented in FIG. 1 by a symbol NO_COUV.

Because of this, when the vehicle CAR attempts to establish a connection from on-board equipment EQ_{CAR} with the data network NET, the failure of the establishment of the communication does not make it possible to transfer data to the remote server SERV. Consequently, the vehicle CAR cannot declare its availability with an automated service for managing a fleet of vehicles.

### Communication Between the Vehicle and the User

The invention allows the establishment of a communication between the equipment EQ₁ of the first user U₁ and the equipment EQ_{CAR} of the vehicle CAR in order to close the phase of use of the vehicle CAR. According to one embodiment, the communication is a short-range communication, denoted L_{CP1}, for example of the Bluetooth type. Any other type of short-range protocol may be used.

According to various embodiments, the activation of the short-range communication L_{CP1} can be initiated:
by the equipment EQ₁ following an action by the user U₁, a transmission of end-of-reservation information then being sent to the equipment EQ_{CAR} of the vehicle CAR. This initiation may be triggered automatically by the user equipment EQ1. In this case, the equipment EQ₁ comprises a function automatically triggering the Bluetooth connection in order to send a message to the vehicle CAR.
Automatically by the on-board equipment EQ_{CAR} of the vehicle CAR following detection of end-of-reservation information. The end-of-reservation information may, for example, be generated by the equipment EQ₁ or by an action by the user U₁ on a command on the dashboard of the vehicle CAR.

According to one example embodiment, the short-range connection L_{CP1} is a Bluetooth connection. Generally, the range of such a Bluetooth connection may advantageously be around fifteen metres. One advantage is to allow a transfer from the equipment of the vehicle CAR of end-of-use information optionally to a user Ui of the service liable to be close to the vehicle CAR. This may have an advantage when the first user U₁ leaves the area of the vehicle precipitously without receiving from the vehicle availability data to be updated with the server SERV.

According to one embodiment, when the equipment EQ_{CAR} of the vehicle CAR detects a failure of the connection with the data network and therefore with the remote server SERV and detects that it is parked or at rest and is receiving end-of-use information coming from the vehicle CAR, it automatically initiates a connection procedure on the short-range connection with the equipment EQ₁ of the user U₁ or with any other equipment of a subscriber to the service liable to be situated in the vicinity.

According to another embodiment, when the user U₁ indicates an end-of-reservation state in order to release the vehicle CAR, he generates a command from his equipment EQ₁. The command then automatically activates the short-range wireless connection L_{CP1} in order to exchange the new availability status of the vehicle CAR.

Once this connection is established, the status of the vehicle CAR is selected from the following statuses: {AVAILABLE; NOT_AVAILABLE}, in the present case as “AVAILABLE”. After a use by a user U1, the vehicle switches its status to “AVAILABLE” subject to another field not being taken into account in the determination of the status of the vehicle CAR.

Activation of the short-range connection L_{CP1} makes it possible to transfer a message M₁ comprising availability information to the equipment EQ₁ or to other equipment of a user of the vehicle reservation service. The availability information is then recorded in the equipment EQ₁ of the user U₁.

The user U₁ then leaves the place where the vehicle CAR is parked, for example by leaving a car park P₁. He is then under the network coverage of the access point PA₁. The equipment EQ₁ can therefore access the data network NET and therefore the server SERV. The invention makes it possible, when the equipment EQ₁ detects the network NET, to transfer the availability information to the server SERV automatically so that the server can update a database of the available vehicles.

The vehicle CAR can then be reserved by another user, for example U₂ in FIG. 1.

FIG. 1 depicts a case of a second user U₂ entering the car park P1 and wishing to reserve a vehicle CAR in the fleet by means of the service offered by the server SERV and a customer application of the equipment EQ₂.

According to one embodiment of the invention, the server SERV then generates a message M₂ comprising free-access information ID_{ACCES} to the vehicle CAR that is transmitted to the equipment EQ₂ for the purpose of its being able to be transmitted to the vehicle CAR if the user U₂ approaches the vehicle CAR sufficiently closely, that is to say within range of the short-range connection L_{CP1} of the vehicle CAR. This functionality enables the vehicle CAR to automatically activate its access by receiving a message M₂ from the server SERV by means of a user U₂ subscribing to the service. According to the circumstances, the user U₂ may have previously reserved the vehicle CAR or have simply made it possible, by means of his equipment EQ₂, to transmit the message M₂ to the vehicle CAR.

Should the vehicle CAR be covered by a data network NET, the method for handing over a vehicle in the stock of available vehicles is implemented by sending a first message from the vehicle to the server SERV in order to indicate the end of a previous use and through the reception of a second message transferring availability of the vehicle so that a user third party can reserve the vehicle. In the context of the invention, it should be stated that the vehicle CAR, not being able to directly transmit the information since it is not covered by the network NET, uses the short-range connection L_{CP1} with at least one item of user equipment EQi in order to transmit the first message M₁ and to receive the second message M₂.

### Method

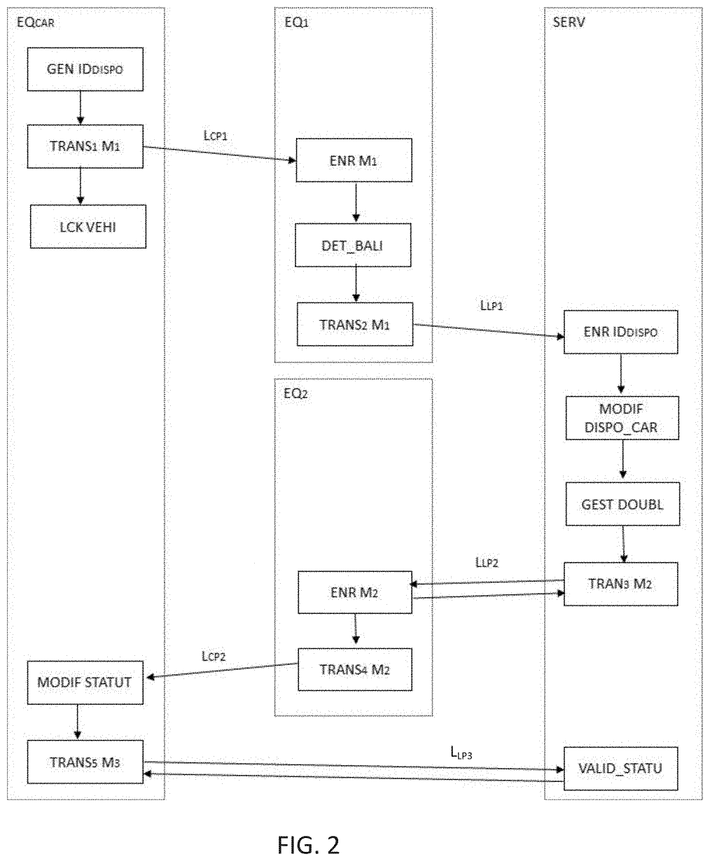

FIG. 2 depicts a block diagram of the main steps of an embodiment of the invention.

FIG. 2 depicts four entities already depicted in FIG. 1, namely the equipment EQ_{CAR} of the vehicle CAR, the equipment EQ₁ of a first user U₁ leaving the vehicle CAR after use thereof, the server SERV hosting in particular at least one vehicle reservation service function and equipment EQ₂ of a user U₂ liable to move in the vicinity of the vehicle CAR or wishing to reserve the latter.

In its first phase, the method makes it possible to generate an availability indicator ID_{DISPO} for indicating to the server SERV that a vehicle CAR is once again available in the fleet of vehicles available after use by a user U₁.

According to one embodiment, the method of the invention comprises a first step GEN_ID_{DISPO} aimed at generating an availability indicator ID_{DISPO} for the vehicle CAR. The latter indicator ID_{DISPO} is generated after detection of information on end of use of the vehicle is received by the equipment EQ_{CAR} of the vehicle CAR. According to one embodiment, the indicator ID_{DISPO} is generated by means of a computer of the vehicle electronic equipment EQ_{CAR}.

According to one embodiment, the method comprises a step TRANS_{1_}M₁ of transmitting a message M₁ from the server SERV to the equipment EQ₁ via a short-range connection L_{CP1}. The equipment EQ_{CAR} therefore comprises a wireless communication interface making it possible to establish short-range connections with third-party equipment.

According to one embodiment, when this transmission fails, the vehicle CAR undertakes a broadcast transmission or a plurality of unicast transmissions with a plurality of items of user equipment Ui liable to be in the vicinity of the vehicle CAR. This case may take place when the first user U₁ does not activate his Bluetooth connection or when an event prevents the short-range connection L_{CP1} from being operational.

Alternatively, as soon as it detects that it cannot be covered by the network NET, the vehicle CAR may by default broadcast a message M₁ by means of a short-range connection with one or more items of equipment detected in the vicinity of the vehicle CAR, whether this be the equipment EQ₁ or another EQi. In this case, the invention makes it possible to temporarily use equipment EQi of a user Ui as a relay for transmitting the message M₁. The resources of the equipment EQi are then used, such as the memory thereof, the computer thereof and the interface thereof to transmit the message M₁. This latter message M₁ will then be resent to the server SERV when the equipment EQi is covered by the network NET.

According to one embodiment, when the vehicle CAR has not succeeded in transferring the message M₁ to equipment EQ₁ or EQi, an automatic periodic reconnection is made so as to favour the positive attempts at sending the message M₁ to the server SERV.

According to one embodiment, the vehicle CAR re-sends the message M₁ until an acknowledgement sent by the server SERV is received by the equipment EQ_{CAR} of the vehicle CAR. In this embodiment, the second phase of the method makes it possible to use a set of equipment EQi of users Ui liable to be in the vicinity of the vehicle CAR for re-sending an acknowledgement or a message M₂ comprising data freeing access to the vehicle CAR, denoted free-access indicator ID_{ACCES}.

According to one embodiment, the equipment EQ_{CAR} sends a command LCK_VEHI locking the vehicle CAR when the message M₁ is sent. This solution secures access to the vehicle CAR even in the case where the first user U₁ does not activate the short-range connection L_{CP1} in order to receive the message M₁ comprising the availability indicator ID_{DISPO}. In this case, the vehicle CAR remains in unavailability status with active locking of the doors while awaiting a return message M₂ coming from the server SERV, for example when a new vehicle reservation is activated.

According to one embodiment, the method of the invention comprises a step of recording the message M₁ in a memory of the equipment EQ₁ (or EQi) when the short-range connection L_{CP1} is activated by the equipment EQ₁ and the equipment EQ_{CAR}. The data of the message are recorded on a memory of the equipment while waiting for the equipment EQ₁ to be able to transmit to an access point P_{A1} of the network NET.

Apart from the availability indicator ID_{DISPO}, the data included in the message M₁ may comprise for example:
An identifier of the vehicle Id_CAR;
An IP address or a URL, in particular of the server SERV hosting the service updating the database of the available vehicles so that the message M₁ is correctly relayed;
A secret KEY shared with a remote authentication server or the server SERV;
A token comprising a timestamp, that is to say a time, for example the time at which the message M₁ was generated.

One advantage of the transmission of the identifier Id_CAR is to limit any errors in particular for qualifying the association between a user Ui and an item of vehicle equipment EQ_{CAR}. The server SERV will then be in a position to check that the vehicle CAR was indeed associated with the user U₁. It will also be able to distinguish various messages coming from the same place in which various vehicles in the fleet are parked.

On advantage of the transmission of the identifier of the server such as its IP address or its URL in the message M₁ is to provide the equipment EQ₁, which fulfils the role of a relay, with an address of the server SERV to which the message M₁ should be transmitted. This may have an advantage in the case of a distributed architecture in which the various services are supported by various servers SERV. By way of example, the services associated with the users may be provided by a first server SERV1 and the services associated with the vehicles are provided by a second server SERV2. In the latter case, the servers SERV1 and SERV2 are synchronised in order to provide updating of the vehicle availability information.

One advantage of sharing a secret between the vehicle CAR and the remote server SERV is protecting the transmission of data between the two items of equipment EQ₁ and EQ_{CAR} and also between EQ₁ and the server SERV. The transmissions can then be encrypted. A symmetrical key system may be established in order to encrypt the transmissions between the various items of equipment. Alternatively, according to another example, an asymmetric key system may be used between on the one hand the server and on the other hand each item of user equipment EQi.

One advantage of the transmission of a timestamp token is processing, on the server SERV, a plurality of receptions of messages M₁ coming from various items of equipment EQi. In the case of a broadcast by the vehicle equipment EQ_{CAR} of information ID_{DISPO} on the availability of the vehicle CAR to a plurality of items of user equipment EQi, the server SERV, receiving possibly various messages M₁, is in a position to manage any doublets.

One example of management of doublets is:
recording the various messages M₁ received
automatically generating a message M₂ comprising an indicator ID_{ACCES} of free access of the vehicle CAR to said vehicle CAR, for example via a plurality of items of equipment EQi liable EQi to move in the vicinity of the vehicle CAR, as soon as the first message M₁ is received;
deletion of the messages M₁ following the first message M₁ received and coming from other items of equipment EQi.

According to one embodiment, the server SERV comprises a function comparing the geographical origin of the messages M₁ in order to corroborate the information before processing same.

According to various example embodiments, the timestamp time may be the time of generation of the messages M₁ by the equipment EQ_{CAR}, the time of reception or sending of the message M1 by the equipment EQ₁.

In order to implement management of doublets, a computer of the server SERV is able to group together the various messages M₁ coming from the vehicle CAR the identifier of which is being analysed. The computer compares the times of the messages M₁ coming from the various items of equipment EQi that relayed the message M₁. One example embodiment comprises the deletion of the doublet messages coming from the vehicle CAR in a predefined time window.

The method comprises a step denoted DET_BALI corresponding to the detection of a beacon or of a point of access PA₁ to a network. This step is performed by user equipment EQi. It may be the user equipment EQ₁ that has just used the vehicle CAR or of another user Ui that is situated in the vicinity of the vehicle CAR and has received a message M₁ coming from the vehicle CAR.

The message M₁ is therefore recorded in a memory of the equipment EQ₁ or EQi until a point of access PA₁ to the network NET is detected.

According to one embodiment, when equipment EQi receives a message M₁, a computer of the equipment can automatically activate a request for access to the network NET, for example by increasing the frequency of the access request vis-à-vis a preconfigured default value.

The method then comprises a step TRANS_{2_}M₁ of the data saved in the memory of the equipment EQi to the server SERV via a long-range wireless connection L_{LPI}, for example of the GSM, GPRS, EDGE, 3G, UMTS, HSDPA, HSPA+, 4G, LTE, LTE-Advanced or 5G, IMT-2020, LTE-B or Wi-Fi type.

The message M₁ is then sent to the remote server SERV. A step ENR_ID_{DISPO} of recording the indicator ID_{DISPO} is undertaken when the message is received by the server SERV.

According to a variant embodiment, the equipment EQ₁ is able to send, to the server SERV, in all cases, whether or not it has received the message M₁, a message indicating that the vehicle CAR is once again available since the user U₁ is no longer using it. According to one embodiment, the server SERV can therefore update its database so that the vehicle can be reserved once again. On the other hand, it is possible for the server SERV to activate the opening or unlocking of the vehicle CAR for a future reservation. The method of the invention therefore comprises a second phase for releasing access to the vehicle for a future reservation.

One advantage of using the message M₁ via user equipment EQ₁ is not changing the processing already existing at the server SERV. The processing consists of updating the database when the vehicle CAR sends an end-of-use message. This modification could take place solely on the basis of a reception of a message generated by the user equipment EQ₁. There is therefore an advantage in implementing this relay mode when the vehicle is blind vis-à-vis the data network.

According to one embodiment, the information on availability of the vehicle CAR coming from the message M₁ makes it possible to validate the making available of the vehicle CAR vis-à-vis the same availability information that would have been solely generated from the equipment EQi to the server SERV.

According to one embodiment, the method of the invention comprises a step of generating and transmitting a message M₂ aimed at releasing access to the vehicle CAR, for example by unlocking access thereto for a future reservation. Advantageously, this step follows, for example, a request for reservation of the vehicle CAR by a user U₂ by means of the service. The reservation being validated by the server SERV, the latter then re-sends at least one message M₂ to the equipment EQ₂ of a user U₂. This step is denoted TRANS_{3_}M₂.

Various cases can be envisaged in the context of the invention. Since the vehicle CAR is not directly accessible via the network NET, the server SERV is able to engage various modes in order to release the vehicle CAR for a future use.

According to a first variant, the server SERV routinely sends to each user Ui in the vicinity of the known location of the vehicle CAR a message M₂ able to be re-sent by the equipment EQi of a user Ui to the vehicle CAR. This possibility makes it possible to make the vehicle CAR accessible to any user of the service entering the zone P1 not covered by the network NET and wishing to reserve it. It makes it possible especially to ensure that the vehicle CAR can be unlocked by increasing the chances of reception of a message M₂ with a plurality of users entering the car park P1.

Another advantage is making the vehicle CAR easily accessible even in the case where the user chooses his vehicle to be rented once in the zone P1, that is to say when he is no longer in connection with the server SERV. Having received the message M₂ before entering the car park P1, the user Ui would be in a position to access the vehicle CAR. For this purpose, the server SERV uses data on location of the users Ui subscribing to the service when the equipment EQ₂ authorises the sharing of the location.

According to a second variant, the server SERV sends a message M₂ solely at the request of a user M₂ wishing to reserve the vehicle CAR. This implementation protects access to the vehicle CAR by limiting access authorisations only once the request for reservation has been made.

According to a third variant, the server SERV sends a message M₂ to a plurality of users of the service only when at least one request for reservation of the vehicle CAR has been validated. Thus, this ensures that the vehicle CAR can be opened and unlocked, for example when the user who reserved the vehicle does not have a short-range connection L_{CP1} active or not functioning. He can then rely on a user network of the service for unlocking access to the vehicle for him.

The method then comprises a step ENR_M₂ of recording the message M₂ in a memory of equipment EQ₂ or a plurality of items of equipment EQi. The message M₂ recorded is then re-sent via a short-range wireless connection L_{CP2}, to the vehicle CAR when possible. The method therefore comprises a step TRANS_{4_}M₂ of transmitting the message M₂ when at least one item of equipment EQ₂ or EQi that has received the message M₂ is in the vicinity of the vehicle CAR. In order to transmit the message M₂, the equipment EQ₂ or EQi will then for example activate its Bluetooth connection in order to detect a vehicle listening out. The equipment comprises a computer and an interface in order to attempt to establish a connection with a vehicle in the fleet.

If a vehicle CAR responds to the request from the equipment EQi, according to one embodiment the equipment EQi checks that the identifier of the vehicle does indeed correspond to the identifier contained in the message M₂. One advantage is protecting the short-range transmission and access to the data exchanged via this connection.

According to another embodiment, the equipment EQi sends the message M₂ to any type of vehicle attempting to establish a connection with the equipment EQi. One advantage of this embodiment is not modifying the processing performed on the equipment EQi. The modifications to processing operations are solely made at the equipment of the vehicle EQ_{CAR}.

When the vehicle CAR receives a message M₂ coming from user equipment EQi, the method comprises a step of modifying the availability status of the vehicle CAR. The vehicle CAR unlocks access thereto and potentially activates the commands making it possible to be operational in order to travel when a user starts the engine of the vehicle CAR.

When the vehicle CAR is reserved by a user U₂ and the equipment EQ_{CAR} of the vehicle detects access to the network NET via a long-range wireless connection L_{LP3}, said equipment transmits a message M₃ to the server SERV in order to update its vehicle data and the association data with a new user U₂. This step is denoted TRANS_{5_}M₃ in FIG. 2. The server SERV updates the data, this step is denoted VALID_STATU in FIG. 2.

### Computer Program

The invention also relates to a computer program product comprising instructions for implementing the various phases of the method of the invention. According to various embodiments, steps can be performed by a computer program of an item of equipment or a plurality of items of equipment EQ₁, EQ₂, EQ_{CAR}. Advantageously, the computer program can be installed on a smartphone or a digital tablet having a wireless communication interface.

According to one embodiment, the computer program comprises various executables recorded on various items of equipment, such as at least one item of equipment of a vehicle and at least one item of equipment of user equipment, the various executables being able to implement the method of the invention.

The invention also relates to a mobile terminal comprising an interface, for example a touch interface. The interface comprises a screen for displaying entry fields for defining parameters relating to the description of the vehicle and for the display for example of an interactive digital map.

According to one embodiment, the mobile equipment comprises a component for obtaining geolocation information that can be recovered by the software. Thus, the request sent by user equipment EQi or vehicle equipment EQ_{CAR} may comprise data entered or defined by the user U₁ and data coming from another component or from other software such as location data on the vehicle or user.

According to one embodiment, the users are pre-entered from the software and are known because an identifier is recorded in a remote database. According to one embodiment, a database associates a vehicle CAR with a user U₁ when the latter uses a vehicle CAR.

The invention also relates to a non-transient recording medium comprising data which, once installed in a computer or equipment of the mobile terminal type, make it possible to execute the method of the invention.

According to another aspect, the invention relates to a system for updating a status of the vehicle CAR, of the motorcar type, in a database of a remote server SERV. The system comprises at least one item of user equipment EQi and vehicle equipment EQ_{CAR} and the data server described previously through the description of the method.

The vehicle is a vehicle comprising equipment having at least one computer and a memory for implementing the steps of the method.

The user equipment may for example be a smartphone. It comprises at least one computer and a memory for implementing the steps of the method.

1-14. (canceled)

15. A method for updating a database for retrieving a vehicle, comprising:
generation of an indicator of availability of the vehicle from a computer of the vehicle;
detection, by equipment of the vehicle, of a failure to connect to a remote server through a data network, said detection initiating an automatic transmission of a set of information comprising said availability indicator to at least one item of user equipment of a first user via a short-range wireless connection;
recording of the set of information in a memory of the equipment when the short-range wireless connection is activated by the user equipment and the equipment of the vehicle;
when the user equipment detects an access to the data network, then automatic transmission of the set of information comprising said availability indicator to the remote server from the user equipment via a wireless connection having access to said data network; and
updating of a database modifying an availability status of a vehicle in a fleet of vehicles by a computer of the remote server.

16. The method according to claim 15, wherein the availability indicator is generated following:
a digital command generated following the stoppage of the vehicle or of its electrical management system, and/or;
a digital command generated following the closure of a door, and/or;
a digital command generated following the reception of a message from a wireless communication interface coming from a user terminal comprising end-of-use data.

17. The method according to claim 15, wherein the automatic transmission of the set of information is performed after a first failed attempt at transmission of said set of information from equipment on board the vehicle, to the remote server, through the data network, and a first recording of said information in a memory of the first item of equipment.

18. The method according to claim 15, wherein the short-range connection is a Bluetooth connection.

19. The method according to claim 15, wherein the set of information comprises:
an identifier of the vehicle;
an IP address or a;
a secret shared with a remote server; and
a token comprising a timestamp.

20. The method according to claim 19, further comprising:
comparison of the tokens and of the identifiers received from a plurality of received messages coming from a plurality of items of equipment; and
deletion of the duplicated availability indicators coming from one and the same vehicle.

21. The method according to claim 15, wherein the updating of the database of the remote server further comprises:
recording of a new parking location of the vehicle;
recording of use data comprising at least one oft:
use time;
distance travelled; and
triggering of events.

22. The method according to claim 15, further comprising modifying the availability status of the vehicle for reservation thereof by a second user, comprising:
identification of the second user recorded in a database of a service for access to a fleet of vehicles;
generation of an indicator of free access to a vehicle;
first transmission by a server to at least one second user of a set of information comprising the free-access indicator;
automatic second transmission of the set of information comprising said indicator of free access to at least one vehicle via a short-range wireless connection;
recording of the set of information received by the vehicle in a memory of said vehicle; and
activation of unlocking of access to the vehicle.

23. The method according to claim 22, wherein the free-access indicator is associated with the identifier of a second user, the second set of information transmitted to the vehicle further comprising a user identifier.

24. The method according to claim 23, further comprising:
reception by the server of a request for access to a vehicle by the second user prior to the generation of a free-access indicator.

25. The method according to claim 22, further comprising, following the identification of the second user:
comparison between at least one position of the vehicle and a position of said second user in order to activate the generation of a free-access indicator for the second user to transmit to the vehicle.

26. The method according to claim 24, further comprising, following the request for access, a selection of a vehicle from the second item of equipment from a list of vehicles generated by said server.

27. The method according to claim 24, further comprising:
detection, by equipment of the vehicle, of access to a data network via a long-range wireless connection;
automatic transmission, by the equipment of the vehicle, of vehicle data and of data for association with the new user to the remote server; and
updating of a database modifying a status of availability of a vehicle in a fleet of vehicles by a computer of the remote server.

28. A system comprising at least one mobile terminal and a server for performing any one of the steps of the method of claim 15.

29. The method according to claim 16, wherein the automatic transmission of the set of information is performed after a first failed attempt at transmission of said set of information from equipment on board the vehicle, to the remote server, through the data network, and a first recording of said information in a memory of the first item of equipment.

30. The method according to claim 16, wherein the short-range connection is a Bluetooth connection.

31. The method according to claim 17, wherein the short-range connection is a Bluetooth connection.

32. The method according to claim 16, wherein the set of information comprises:
an identifier of the vehicle;
an IP address or a URL;
a secret shared with a remote server;
a token comprising a timestamp.

33. The method according to claim 17, wherein the set of information comprises:
an identifier of the vehicle;
an IP address or a URL;
a secret shared with a remote server;
a token comprising a timestamp.

34. The method according to claim 18, wherein the set of information comprises:
an identifier of the vehicle;
an IP address or a URL;
a secret shared with a remote server;
a token comprising a timestamp.
